(19) United States
(12) Patent Application Publication
(10) Pub. No.: US 2008/0134802 A1
(43) Pub. Date: Jun. 12, 2008

(54) Torque sensor

(75) Inventor: Paul D. Okulov, St-Anne de Bellevue (CA)

Correspondence Address: OGILVY RENAULT LLP, 1981 MCGILL COLLEGE AVENUE, SUITE 1600, MONTREAL, QC, H3A2Y3, omitted

(73) Assignee: Turbo Trac Systems ULC, Ville St-Laurent (CA)

(21) Appl. No.: 11/634,124

(22) Filed: Dec. 6, 2006

(51) Int. Cl. G01L 3/10

(52) U.S. Cl. 73/862.325

(57) ABSTRACT

A torque sensor is disclosed. The sensor has a support member for mounting to a rotatable shaft and a flexible electro-conductive member pre-tensioned and mounted to the support. An electrical coil is positioned in electrical communication with the support member and electro-conductive member. A magnetizing system is positioned adjacent the support member. The sensor is passive and operates on energy received from its rotation relative to the stationary magnetizing means. A receiver remotely detects electrical changes from the movement of the flexible member from torque experienced by the rotatable shaft.

### CROSS-REFERENCE TO RELATED APPLICATIONS

This is the first application filed for the present invention.

### TECHNICAL FIELD

The present invention relates to a torque sensor and method of using the sensor and more particularly, the present invention relates to a torque sensor for quantifying torque experienced by a rotating shaft.

### BACKGROUND OF THE INVENTION

Preface

As is well established, torque is rotational force. When torque is applied to an object with angular acceleration, the same is referred to as dynamic torque. The quantity of torque realized is proportional to the applied force and to distance from the center of the rotation.

Generally, torque sensors employ resistance strain gages or electromagnetic devices for detection. For operation of strain gages deformation of some part of the shaft or an additional member is required. Magnetic type sensors will primarily read change in magnetic properties of the shaft or an additional member.

Torque sensors have previously used a principle of operation based on the Villary effect, where magnetization of a magnetic material changes upon stretching, compression twisting, bending or other deformation is experienced by the material. Deformation of the shape of the material distorts the shape of the crystals that make up the material. This changes the direction the domains face, which in turn changes the direction and strength of the material's magnetic field. Such materials are magnetoelastic materials or pseudo-magnets.

Any type of torque sensor producing electric output and which is not a direct part of the rotating member or shaft is typically referred to as a torque transducer.

With reference now to the prior art, Eckerle, in U.S. Pat. No. 4,977,784, issued Dec. 18, 1990, teaches a torque sensing apparatus for an axle spindle load. Eckerle discusses a vehicle load sensor apparatus for measuring the load on one or more spindles of a vehicle axle. The concept uses a string attached to the vehicle spindle and a measuring device for measuring tension fluctuations in the string. Tension in the string is measured by inducing vibration and measuring the frequency of vibration of the string. The change is determined by comparison of measured tension to the tension in the string previously measured under no-load conditions.

Although a useful device, the necessity to attach a fairly long string to the heavily modified shaft limits the scope and applicability of this device. Moreover, unbalanced centrifugal forces establish error and reduced frequency of the vibration of the string leading to lower resolution in such devices.

In U.S. Pat. No. Re 34,039, issued to Kobayashi et al., Aug. 25, 1992, a further variation on the torque sensor is set forth for detecting shaft torque. In this document, a non-contact type sensor is taught. This type of sensor facilitates torque measurement, but is limited by an insufficient signal to noise ratio in the environment of external magnetic noise, such as an induction magnetic flux. On an induction motor, the torque sensor is mounted in non-contacting relation. Shaft torque is detected using a pair of magnetic material members provided on circumferential portions of the peripheral surface of a shaft. Magnetic detectors are disposed at opposite locations at which external magnetic fields having opposite phase exist. The detectors detect magnetic of the magnetic materials. A signal processing circuit produces output signals obtained from the magnetic detectors.

The system uses ribbons and as stated by the Patentee:

“ . . . a magnetic sheet, preferably an amorphous magnetic ribbon 4 is arranged along the circumferential direction of the shaft 20 and is fixed and bonded to the shaft 20 to which rotary torque is applied.”

It is apparent that the critical bond between the sensor and shaft shall remain as such at all times in order for the device to function properly. Further, the system may produce erroneous readings in situations where the temperature of the environment fluctuates in which the system is used.

A specific application to strain gauge and magneto restrictive torque sensors is provided in U.S. Pat. No. 5,483,820, issued to Nakamoto et al., Jan. 16, 1996. The document establishes a method for zero correction in torque sensors. It is stated in the document that the method permits proper measurement and correction of zero signals from torque sensors employed successively at locations subject to impulse-like action of a torque load. However, such devices require very sensitive circuitry to amplify the signal and subsequently transmit it to the receiver, which greatly complicates the system.

It would be particularly desirable to have a torque sensor capable of automatic zero and acceleration forces correction and which may be used in a variety of situations and environments while presenting a low cost.

The present invention provides for such a device and mitigates the restrictions of the prior art systems and methods.

### SUMMARY OF THE INVENTION

One object of the present invention is to provide an improved torque sensor and methodology of use.

A further object of one embodiment of the present invention is to provide a torque sensor, comprising: a support member for mounting to a rotatable shaft; a flexible electro-conductive member pre-tensioned and mounted to the support member; coil means positioned in electrical communication with the support member and the flexible electroconductive member; magnetizing means positioned adjacent the support member; and detection means for detecting electrical changes from the movement of the flexible member from torque realized by the rotatable shaft.

In one embodiment, the sensor provides a unique arrangement of the flexible electro conductive member and coils which cooperate to sense torque variations. By the provision of the flexible electro conductive member extending within a support, pre-tensioning of the electro conductive member is possible and when combined with a similar sensor on opposed sides of a rotatable shaft with a respective flexible electro conductive member in orthogonal relation, the result is a zero torque calibration.

Conveniently, the flexible electro conductive member comprises a material selected from the group consisting of metal, electro conductive fiber, electro conductive composites, electro conductive laminates, electro conductive material deposition on non electro conductive support and suitable combinations thereof.

Ancillary equipment in the form of analysis equipment, signal processors inter alia also form part of the invention and assist in transforming the data obtained into useful information which can be further disseminated to predict mechanical fatigue, age, projected time of failure etc. This is particularly useful for turbine shafts in turbo-jet engines, steam generators, oil well pumps, variable transmission, hybrid engines and automobiles, high performance racing cars, amusement rides, aircraft and any other device incorporating a rotatable shaft.

In view of the aforementioned, another object of one embodiment of the present invention is to provide a torque sensor, comprising: a first support member and a second support member for mounting in opposed relation to a rotatable shaft; a flexible electro-conductive member pre-tensioned and mounted to each the support member; coil means positioned in electrical communication with each the support member and the flexible electro-conductive member; means for inducing movement of the flexible electro-conductive member or string to create detectable electrical signal; receiver means for receiving the electrical signal; and analysis means for analyzing received signals whereby toque experienced by the shaft may be determined.

Having thus generally described the invention, reference will now be made to the accompanying drawings illustrating preferred embodiments.

### BRIEF DESCRIPTION OF THE DRAWINGS

Further features and advantages of the present invention will become apparent from the following detailed description, taken in combination with the appended drawings, in which:

FIG. 1 is a schematic illustration of the difference in length experienced when a length of string is strained;

FIG. 2 is a schematic graphical representation of frequency of a string or other flexible member as a function of range of strain;

FIG. 3 is a partially cut away view of a rotating shaft indicating an orthogonal relationship between electro-conductive flexible members on a opposed sides of the shaft;

FIG. 4 is a view along line 44 of FIG. 3;

FIG. 5 is an enlarged view of the sensor according to one embodiment with elements removed;

FIG. 6 is a cross-sectional view of the sensor according to a further embodiment;

FIG. 7 is an enlarged view of the sensor similar to FIG. 5 with parts removed, but displaying the disposition of the coils relative to the electromagnetic flexible member;

FIG. 8 is a schematic illustration indicating deformation of an electromagnetic member in the presence of a magnetic field;

FIG. 9 is a schematic illustration of one possible arrangement for the sensor together with ancillary equipment;

FIG. 10A is a schematic illustration of a typical signal pattern representative of sensed torque;

FIG. 10B is a resolved view of the signal components;

FIG. 11 is a further enlarged view of the signal pattern where the period of vibration is representative of torque experienced.

It will be noted that throughout the appended drawings, like features are identified by like reference numerals.

### DETAILED DESCRIPTION OF THE PREFERRED EMBODIMENT

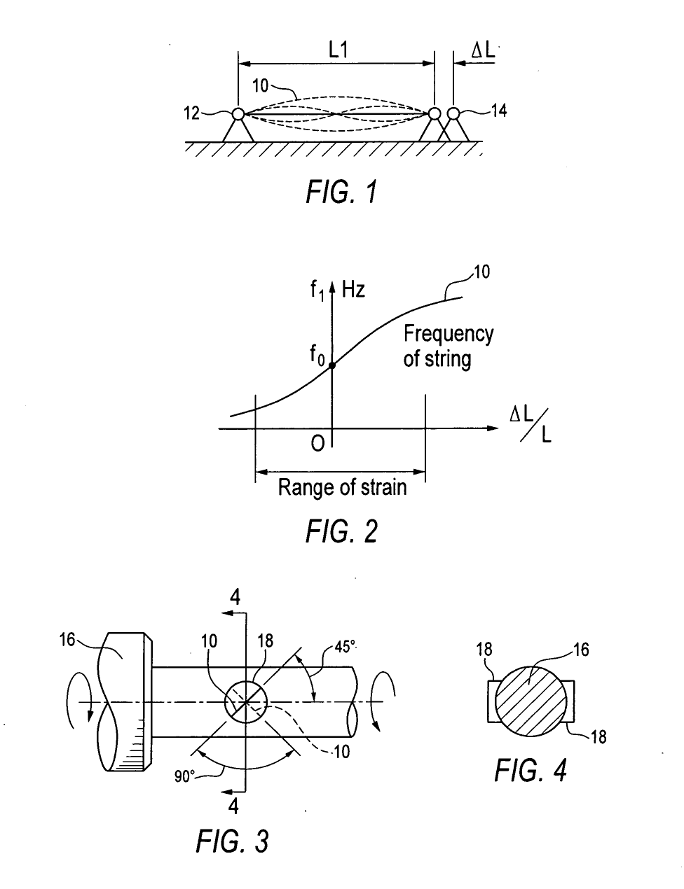

Referring now to the drawings, shown is a schematic illustration of the strain and length relationship between a flexible length of material denoted by numeral 10 positioned between two fixed points 12 and 14. It is known that where a strain is experienced by the flexible length 10 there is a change in the length of the string denoted in FIG. 1 by Δl.

Referring to FIG. 2, the flexible length 10 and for that matter, any material has a natural frequency (the residence frequency). By pre-tensioning a flexible length material and in the instant case a length of flexible material suitable for electro-conductive purposes, the fundamental frequency fₒ can be found. This value is known as the fundamental frequency and deviations from this frequency are therefore indicative of strain.

With reference to FIG. 3, shown is a partially cut away view of a rotatable shaft 16 where the shaft 16 has positioned thereon sensor members 18. It is to be noted these sensors 18 register in alignment and in this manner are co-axially disposed. This is clearly shown in FIG. 4. By providing the flexible member 10 extending diametrically within the sensor 18 and in orthogonal relation to a similar flexible member on the opposite side of the rotatable shaft, a zero or baseline is therefore established for measurement of torque fluctuations in use. In this manner, the zeroing of the torque fluctuations in the rotatable shaft are automatic.

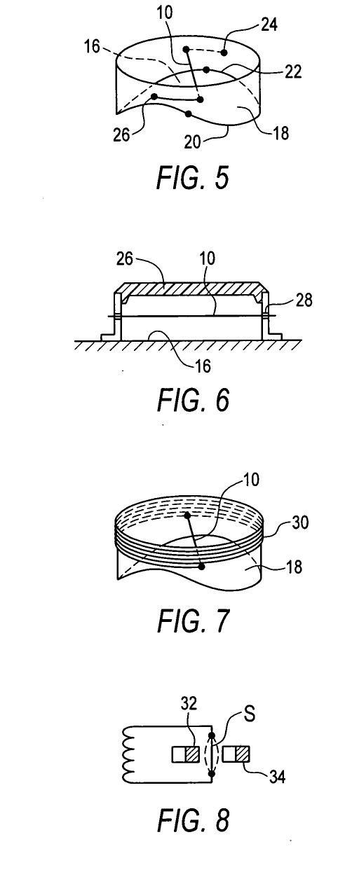

Referring now to FIGS. 5 through 7, shown are illustrations depicting greater detail of the sensor system. In one embodiment, the sensor provides for a support member in the form of a ring 18, which support member may comprise an electro-conductive material such as, for example, ferromagnetic foil. Other suitable materials may be incorporated and this will depend upon the intended use and environment of the overall structure. The support member also may include a contour 20 in order to conform with the surface of the shaft 16 to which it is mounted. This is shown in FIG. 5 as having a generally concave structure. Furthermore, the support port member 18 may be continuously affixed to the surface of the shaft 16 or, alternatively, intermittently attached as shown by the points of contact represented by numeral 22. A suitable fastening means will be appreciated by those skilled in the art. As illustrated in FIG. 5, the flexible member or electro-conductive flexible member or string 10 is fixedly secured within the body 18 of the support member and more particularly, is fastened therein and extends diametrically therein. As indicated by numerals 24 and 26, the electro-conductive string is capable of movement in a radial direction in either direction position 24 or 26. This would occur, for example, during any torque that is experienced by the shaft.

FIG. 6 provides a partially cut away view of a further embodiment of the sensor. In this embodiment, a cap 26 is provided atop the body 18 of the sensor. The flexible electro-conductive member 10 extends diametrically of the body 18 and is electrically isolated at the perimeter of the body 18 as denoted by numeral 28. The use of the cap may provide utility and environments where heavy fluid deposit is possible or generally wet environments or any other environment where damage could occur to the electro-conductive flexible member.

In FIG. 7, shown is an embodiment of the sensor 18 where the flexible electro-conductive member 10 is connected to a coil or a series of coils of electro-conductive material 30. In this arrangement, excitation of the flexible member 10, will result in the induction of a current through the coil arrangement 30. This is generally referenced in FIG. 8. FIG. 8 opposed permanent magnets 32 and 34 are within a sufficient distance of a fixed string, generically referred to by S. This results in movement of the string which induces currents through the coil which can be subsequently detected.

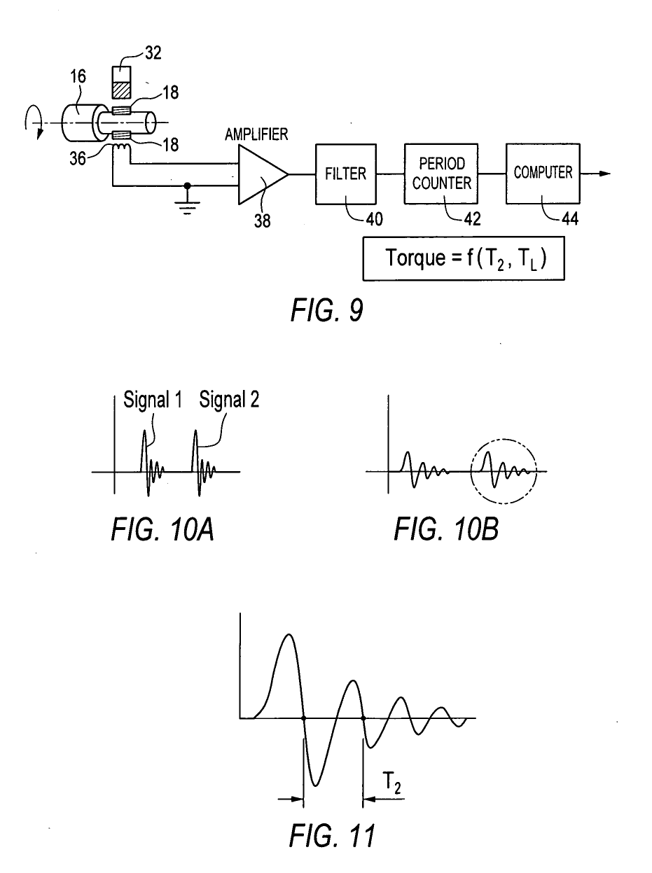

In FIG. 9, shown is one possible embodiment of the torque sensors in use with ancillary equipment. In the arrangement, the sensors 18 are in opposition on shaft 16 and positioned adjacent a magnet 32 and coil 36. During rotation of the shaft 16, variations in the torque of rotating shaft 16, will of course, result in variation of tension and frequency of oscillations of flexible electro-conductive members in each of the sensors 18. This results in the generation of an electric current which is transmitted to and received by the coil 36. These variations in electric current are then subjected to amplification at 38, filtration at 40 and a period counting device for detecting time frames between pulses at 42 and finally the computer 44 for analyzing the data.

The signals received are represented in FIG. 10A as a first set of signals from one of the sensors and a second set of signals from the other of the sensors in FIG. 10B. It is known that torque is a function of the periods of the current from each of the sensors and this is what is represented from FIG. 11; FIG. 11 is indicative of the period from the second sensor which is representative of the torque realized by the shaft.

In terms of the electro-conductive flexible member, any suitable material may be used such as suitable metals, electro-conductive fibers, electro-conductive composites, electro-conductive laminates, electro-conductive material deposited on non electro-conductive or semi-conducting supports or any suitable combination of these materials.

Conveniently, the electro-conductive member may be in the form of at least one of a string, a band, foil, fibre, mesh or a combination thereof.

The support of the sensor may comprise any suitable metal and be in the form of a ring or may comprise a ferromagnetic foil or laminate thereof.

The arrangement has particular utility in detecting torque variations for rotatable shafts which may be in any article such as automotive products, turbines, aircraft, inter alia.

The embodiments of the invention described above are intended to be exemplary only. The scope of the invention is therefore intended to be limited solely by the scope of the appended claims.

I/We claim:

1. A torque sensor, comprising:
a support member for mounting to a rotatable shaft;
a flexible electro-conductive member pre-tensioned and mounted to said support member;
coil means positioned in electrical communication with said support member and said flexible electro-conductive member;
magnetizing means positioned adjacent said support member; and
detection means for detecting electrical changes from the movement of said flexible member from torque realized by said rotatable shaft.

2. The torque sensor as set forth in claim 1, wherein said flexible electro-conductive member comprises a material selected from the group consisting of metal, electro-conductive fiber, electro-conductive composites, electro-conductive laminates, electro-conductive material deposition on non electro-conductive support or combinations thereof.

3. The torque sensor as set forth in claim 2, wherein said electro-conductive material is in the form of at least one of string, band, foil, fibre, mesh or combinations thereof.

4. The torque sensor as set forth in claim 1, wherein said support member comprises a metal ring.

5. The torque sensor as set forth in claim 4, wherein said electro-conductive member comprises a string pre-tensioned and extending diametrically within said ring.

6. The torque sensor as set forth in claim 4, wherein said metal ring comprises ferromagnetic foil.

7. The torque sensor as set forth in claim 1, wherein said support member is contoured in a shape complementary said rotatable shaft.

8. The torque sensor as set forth in claim 7, wherein said support member is mounted to said rotatable shaft at least in intermittent relation.

9. The torque sensor as set forth in claim 1, wherein said sensor includes a second sensor.

10. The torque sensor as set forth in claim 9, wherein said second sensor is mounted to said shaft in opposed relation with said sensor.

11. The torque sensor as set forth in claim 9, wherein said second sensor includes a flexible member or string pre-tensioned and extending diametrically within said ring.

12. The torque sensor as set forth in claim 9, wherein said string of said sensor and said string of said second sensor are positioned on said rotatable shaft in orthogonal relation.

13. The torque sensor as set forth in claim 1, wherein said magnetizing means comprises at least one permanent magnet.

14. The torque sensor as set forth in claim 1, wherein said detection means includes amplifier means.

15. The torque sensor as set forth in claim 1, wherein said detection means includes signal filter means.

16. The torque sensor as set forth in claim 1, wherein said detection means includes means for analyzing filtered signal means.

17. A torque sensor, comprising:
a first support member and a second support member for mounting in opposed relation to a rotatable shaft;
a flexible electro-conductive member pre-tensioned and mounted to each said support member;
coil means positioned in electrical communication with each said support member and said flexible electro-conductive member;
means for inducing movement of said flexible electro-conductive member or string to create detectable electrical signal;
receiver means for receiving said electrical signal; and
analysis means for analyzing received signals whereby toque experienced by said shaft may be determined.

18. The torque sensor as set forth in claim 17, wherein said flexible electro-conductive member comprises a material selected from the group consisting of metal, electro-conductive fiber, electro-conductive composites, electro-conductive laminates, electro-conductive material deposition on non electro-conductive support or combinations thereof.

19. The torque sensor as set forth in claim 17, wherein said flexible electro-conductive member comprises a material selected from the group consisting of metal, electro-conductive fiber, electro-conductive composites, electro-conductive laminates, electro-conductive material deposition on non electro-conductive support or combinations thereof.

20. The torque sensor as set forth in claim 18, wherein said electro-conductive material is in the form of at least one of string, band, foil, fibre, mesh or combinations thereof.

21. The torque sensor as set forth in claim 17, wherein said support member comprises a metal ring.

22. The torque sensor as set forth in claim 20, wherein said electro-conductive member comprises a string pre-tensioned and extending diametrically within said ring.

23. The torque sensor as set forth in claim 20, wherein said metal ring comprises ferromagnetic foil or laminate.

24. The torque sensor as set forth in claim 17, wherein said support member is contoured in a shape complementary said rotatable shaft.

25. The torque sensor as set forth in claim 21, wherein said support member is mounted to said rotatable shaft at least in intermittent relation.

26. The torque sensor as set forth in claim 17, wherein said sensor includes a second sensor.

27. The torque sensor as set forth in claim 26, wherein said second sensor is mounted to said shaft in opposed relation with said sensor.

28. The torque sensor as set forth in claim 26, wherein said second sensor includes a string pre-tensioned and extending diametrically within said ring.

29. The torque sensor as set forth in claim 26, wherein said string of said sensor and said string of said second sensor are positioned on said rotatable shaft in orthogonal relation.

30. The torque sensor as set forth in claim 1, wherein said means for inducing movement comprises permanent magnets.

31. The torque sensor as set forth in claim 1, wherein said detection means includes amplifier means.

32. The torque sensor as set forth in claim 17, wherein said receiver means includes an electromagnetic coil.
